(19) United States
(12) Patent Application Publication
(10) Pub. No.: US 2020/0210990 A1
(43) Pub. Date: Jul. 2, 2020

(54) INTELLIGENT DISPLAY OF LOCATION-SPECIFIC GRAPHICS BASED ON DEVICE METADATA

(71) Applicant: Paypal, INC., San Jose, CA (US)

(72) Inventors: Kevin Laracey, San Jose, CA (US); Anthony Shakrala Allen, Orinda, CA (US)

(21) Appl. No.: 16/237,571

(22) Filed: Dec. 31, 2018

(51) Int. Cl. G06Q 20/32; H04W 4/021; H04L 12/58; G06Q 30/02

(52) U.S. Cl. CPC G06Q 20/3278; G06Q 30/0226; H04L 51/10; H04W 4/021

(57) ABSTRACT

There are provided systems and methods for intelligent display of location-specific graphics based on device metadata. A device or a service provider may detect device metadata during data processing, which may be used to determine a specific graphical icon or emoji that can be utilized in messaging associated with the data processing. For example, during transaction processing, a device may be detected at a merchant location based on transaction metadata. The merchant location may have a specific emoji that may be utilized for the merchant location and in messages sent while associated with the merchant location and/or processing a transaction at the merchant location. The device or service provider may populate the emoji in an interface of the device in place of or with a standard emoji that can be utilized with the message. The emoji may be selectable when entering text of the message or replace entered text.

### TECHNICAL FIELD

The present application generally relates to graphical object selection and display in device interfaces, and more specifically to intelligent determination of location-specific graphical objects for use during messaging.

### BACKGROUND

Users may utilize communication devices to perform various actions, including use of user accounts, which may be associated with email, transaction processing services, social networking, messaging, and other actions associated with online and offline accounts for the users. During use of the device services and applications, users may wish to communicate with each other and/or post information for others to view through messaging. Users may add graphical objects, such as “emojis” or emoticons used to convey some message, emotion, word, or phrase. Users may also add other types of still or animated images. However, these graphical objects and images are generally standardized and require a user to navigate through large amounts of data in order to find particular graphical objects or images that the user would like to add to a message. Additionally, the graphical objects and images provide no way to track user messaging and/or provide data back to the user in response to their use.

### BRIEF DESCRIPTION OF THE DRAWINGS

FIG. 1 is a block diagram of a networked system suitable for implementing the processes described herein, according to an embodiment;

FIG. 2A is an exemplary real-world environment where device and/or transaction metadata may be generated for intelligent display of location-specific emojis, according to an embodiment;

FIG. 2B is an exemplary graphical user interface of an application displaying location-specific emojis selected for output based on detected device and/or transaction metadata, according to an embodiment;

FIG. 3 is an exemplary system environment having detectable metadata used to display location-specific emojis on a computing device, according to an embodiment;

FIG. 4 is a flowchart of an exemplary process for intelligent display of location-specific graphics based on device metadata, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for intelligent display of location-specific graphics based on device metadata. Systems suitable for practicing methods of the present disclosure are also provided.

Emojis may be used in electronic communication to convey a feeling, mood, activity, item or object, or other type of everyday occurrence. For example, similar to expressions conveyed by a physical appearance of a user, an emoji may be used to convey an emotion, thought, idea, or other expression. In this regard, an emoji may often correspond to a small image or icon conveying the emotion, activity, or other occurrence happening for a user in a small interface graphical object. These may be small in display size and/or data size, but may also be displayed in large form, be animated and larger in data size, etc. Other graphical objects may also be used in a similar manner, such as images, icons, animations (e.g., .GIF files or “memes” that may correspond to a activity or concept related in an image, video, animation, or text), or other data. An emoji may be entered to electronic communications, which are used to convey the displayed occurrence to another user receiving the emoji. For example, an emoji may be sent through a text message, email, social networking platform, microblogging platform, media sharing service, or other messaging service, where one or more other users may view the emoji and determine the associated occurrence with the emoji. The emoji may be used to inform another user of something currently occurring or that just recently occurred that is specific to a location. However, emojis are generic and do not provide specific details associated with the location. Additionally, emojis may be interpreted differently by different users and/or groups of users. For example, interpretations of emojis may be user specific, location specific, specific to certain cultures and/or nationalities, or otherwise interpreted different depending on the social settings of the user sending and/or receiving the emoji. Thus, merchants and/or service providers may wish to provide location-specific emojis to provide better communications between parties and better identify the merchant or occurrence at a location.

In order to provide location-specific suggestion and output of customized emojis and/or other graphical objects (e.g., icons, images, animations, etc.), data and/or metadata associated with a user, transaction, location, and/or device is detected. In some embodiments, the data may correspond to a geo-location of a user device for the user, which may be matched to a merchant location or a known location associated with a location-specific emoji. This may also correspond to a geo-fenced area for the location-specific emoji that the user device is detected within. In some embodiments, the user device may also be detected as within a proximity to a merchant device or other device at the location, such as a point-of-sale (POS) or checkout device where the user and/or user device may perform transaction processing. The detection of the proximity range between the devices may correspond to a short range wireless communication range. Therefore, the detection of the proximity between the device may correspond to exchanged communications between the devices, such as one or more of the devices pinging each other, sharing data, and/or performing a check-in of the user device at the location through short range wireless communications. The check-in at the location may also be performed over a network connection by the user device, such as with the merchant device at the location, the service provider that provides location-specific emojis, and/or a social networking platform or service provider that provides location-specific check-ins for users.

In some embodiments, the data and/or metadata used to determine a location-specific emoji may be generated and/or detected through a transaction initiated by the user device with a merchant at the location and/or merchant device at the location. The transaction may be generated to purchase one or more items (e.g., goods, services, and/or products) at the location of the user device. The transaction data may be entered to an application on the user device, such as a transaction processing and payment application that allows the user to checkout and purchase one or more items. The transaction data may include a designation of a merchant and/or merchant location (e.g., merchant and/or location identifiers) when the transaction data is entered, and may also include one or more items, total for the items, and additional information (e.g., tax, tip, etc.). The transaction data may also include additional metadata, such as a transaction location, timestamp, or other transaction detail describing the transaction. Additionally, the transaction data may include designation of a merchant device, such as a merchant device identifier, which may be used by the user device, merchant, and/or service provider to determine a specific location of the user device and a merchant device that the user is interacting with. This merchant device identifier may be entered by the user, retrieved through short range wireless (e.g., NFC/Bluetooth) and/or network communications, and/or pushed to the user device from the merchant device.

In some embodiments, the merchant device may instead initiate and generate the transaction with the user and/or the user device. The merchant device at the location may identify the user and their associated device through a user identifier and/or user device identifier that is entered to the transaction data for payment and checkout. The merchant device may also receive a payment instrument, such as a credit/debit card for the user, which may be used to identify the user to the merchant device and/or service provider, and further may be used to communicate with the user device. The data entered by the merchant device may include similar transaction data and metadata as discussed above. The user device may receive information for the transaction from user input and/or the merchant device for determination of a location-specific emoji, or the service provider may receive the transaction data from the user device and/or merchant device for determination of the location-specific emoji.

In some embodiments, the transaction data may also be generated and/or processed from data received by the service provider, such as transaction processing data that occurs after receiving a transaction processing request from the user device and/or merchant device and processing the corresponding transaction data. For example, a transaction processor may receive transaction data, which may include transactional information (e.g., items, costs/totals, merchant identifiers for payment, etc.), a user device and merchant device identifier, a geo-location, a payment instrument (e.g., a payment card, account, token for tokenized data), and/or wireless communication information. The service provider may utilize some or all of the data to determine a location of the user, for example, through a merchant device identifier, geo-location and geo-fenced area, etc., and may further determine a location-specific emoji based on the data. The service provider may add or determine additional metadata for the transaction processing data, such as a timestamp, location of the transaction, transaction processing result, and other information.

In some embodiments, the user device may also be used to capture images, including digital cameras, mobile smart phones, tablet computers, digital video recorders, gaming systems including mobile gaming systems, and other types electronic devices capable of capturing images or videos. Thus, although the terms “image,” “video,” or the like may be used throughout, it is understood that other forms of visual data may also be captured, including infrared visual data, x-ray data, or other types of visual media content or data that may be detected by an imaging device, such as a camera, infrared sensor, photodetector, etc. Such data may be used to determine a location of the user device and/or a location-specific emoji. For example, an image may be processed to determine a location and/or item/event occurring in the image through image processing and object recognition. The image may also include a timestamp, geo-location tag, or other metadata to determine a location of the user and event or other occurrence at the location.

In further embodiments, additional data and metadata for the transaction, devices, and/or location may be accessed, determined, and/or processed to determine one or more location-specific emojis for presentation to the user on the user device. For example, additional data and metadata may be taken from a text message, instant message, or social networking/microblogging post that the user is currently typing and/or has previously sent to another user or posted to a feed. The text may be parsed to determine certain works, phrases, and/or other information within the message. In some embodiments, a machine learning engine may be utilized to understand the semantics and syntax of the message being typed or previously sent/posted by the user, for example, by generating word vectors from the message and processing the word vectors with previously known embeddings to understand content of the message. The message content may therefore include transactional details, items purchased, amounts, merchants, etc. The message may also be associated with additional metadata, such as a timestamp of the message, receiving user or feed of the message, application used to generate and send the message, time of day or year (e.g., daily or seasonal trends for the message, such as Christmas), and/or other message metadata. In some embodiments, additional user metadata may be accessed or determined to influence selection of a location-specific emoji. For example, different user roles or groups may be associated with a location, such as customers, students, clients, employees, etc. User employment data and/or reason for visiting a location may be determined based on user metadata. Device metadata may also be accessed or determined, such as a device type, processing platform, installed applications, device fingerprint, or other device metadata.

The aforementioned location, image, transactional, and/or other data and metadata may be used to determine a location that may be associated with a location-specific emoji that may be presented to the user. For example, where the user is at a specific chain of pizza restaurants, a pizza emoji may be replaced with an emoji specific to that chain, such as a chain name, design, or trademark. Other merchant identifying symbols for the location may also be used that would convey the particular location to other users. The aforementioned data and metadata may also be used to select from a plurality of location-specific emojis that may correspond to different contexts, occurrences, transactions, and/or emotions for an emoji and associated with the location. Thus, selection of the location-specific emoji(s) to present to the user may be based on additional information and available emojis for the location than just the location information. For example, the location-specific emoji may also be generated based on the specific emotion, transaction, occurrence, and/or action at the location that the emoji is replacing or meant to convey. This may also be based on specific actions, items, and/or occurrences at the location, for example, specific items and/or services that may be for sale at the location. For example, a department store chain for the location may include location-specific emojis identifying the particular department store chain, as well as certain items that may be purchased exclusively at the department store chain. Similarly, a pizza restaurant may include location-specific emojis with eating in, ordering to-go or delivery, purchasing a single pizza or slice for an individual purchase, and/or purchasing pizza for a party.

In some embodiments, the location-specific emoji may replace another generic emoji that may generally be displayed to the user, for example, by exchanging the generic emoji in a menu, interface, or option with the location-specific emoji. When replacing the location-specific emoji, the user may be provided with an option to revert to the generic emoji. In other embodiments, the location-specific emoji may instead be displayed alongside or next to the generic emoji or may be selectable from the generic emoji (e.g., with an option to change to the location-specific emoji). Additionally, the location-specific emoji may replace text or may be provided with an option to replace the text in the message being generated by the user. For example, the text may correspond to one or more of the location-specific emojis (e.g., “happy,” “pizza,” “merchant name,” “merchant location,” and the like). The population and/or replacement of the location-specific emoji may occur by the device through an application and/or application extension. The device may replace the emoji based on device-side processing and a stored library of location-specific emojis. In other embodiments, the service provider associated with the messaging and/or location-specific emoji provision may determine one or more location-specific emojis and may push those emojis to the user device and cause display and population of those emojis with messages through an application and/or application extension on the user device. Thus, the user may be presented with the one or more images, icons, and/or emojis specific to the location.

The user may then utilize the location-specific emoji in one or more messages, which may cause the emoji to be entered to the message and transmitted or posted with the message. The user may also switch between location-specific emojis and generic emojis when transmitting/posting the message and may utilize the emojis in an interchangeable manner depending on desired conveyance of information with the emojis. A service provider may further track usage of the location-specific emoji(s) to determine prevalence of use of the emoji(s) and what the emojis are used for. This may allow tracking of visitations to a merchant location, transaction processing, and customer flow at a location. The data may be used to determine a number of customers visiting over a time period, when the customers visit (e.g., visitation patterns and flow), and what the customers visit the location for (e.g., what they purchase). Thus, each location-specific emoji may be associated with an identifier or other data allowing for identification of uses of the emoji(s).

Additionally, the service provider may parse data and text within the message to determine what the customers are saying or posting about locations. Such data may be provided to the merchants for use in marketing or advertising. For example, the merchant and/or service provider may be able to provide an advertisement back to users in response to utilizing an emoji. The merchant and/or service provider may be able to provide a badge or recognition of the user's business and use of the emoji, which may be earned based on specific interactions and/or uses of the emoji at the location. The merchant may also utilize a platform to interact back with the user and provide messages or contact back to the user which recognize the user's visitation to the location, use of the emoji, and actions at the location. For example, merchant employees associated with the location may reply to the user, where the posts or messages may be identified using the location-specific emoji. Additionally, an authorized user with the merchant may see all interactions with the merchant using the location-specific emoji and may reply to the user.

In some embodiments, an authorized user, such as a merchant, manager, celebrity, or brand owner, may be capable of managing and changing their emoji content that is output utilizing the processes described herein. For example, a manager of a merchant or other emoji content provider may be capable of providing new emojis or changing the features of the previously provided emojis. The manager may be capable of providing and/or updating their emoji content that is provided to users in order to maintain the relevance and significance of such content. This may include adjusting the features, display, graphics, animation, or other feature of such emoji or other graphical object. The manager may make such adjustments based on new incoming information in order to provide users with a more relevant or useful emoji for their current needs. For example, a manager may view previous comments utilizing emojis and may wish to enact or adjust an emoji to provide a better recognition of customer satisfaction and/or interaction with that manager's business. The service provider may provide a system, such as an online website or portal that may allow the manager to adjust such features of one or more emojis. A system operator, such as an administrator of the system, may provide review of such changes to the emojis in order to ensure compliance with the system and provide feedback for these changes. This may be done through image recognition and matching by a machine to prevent unallowable material in emojis from being published and/or provide user responses to new emojis (e.g., usage rates, users comments, and the like) to the manager. The manager may be responsible for a fee to enable these new and/or adjusted emojis, which may be captured and processed by the service provider. In some embodiments, this may be processed on a “per-emoji” basis, a “per-edit” basis, or as a flat fee for utilizing the services provided by the service provider to enable location-based emojis for the manager's business.

In this manner, a merchant and/or service provider may populate and output data specific to locations to allow for more detailed messaging between users. This allows users to more accurately and specifically communicate location-specific data to other users using electronic communications. This allows users to covey a larger and more specific set of data between users. Additionally, by utilizing location-specific graphical objects, interactions between users and data posts may be more easily tracked and associated with particular locations and occurrences, which reduces the need for data aggregation and parsing through large sets of data. This allows user messaging and posting of data to be more accurately found in a faster and less processing intensive manner.

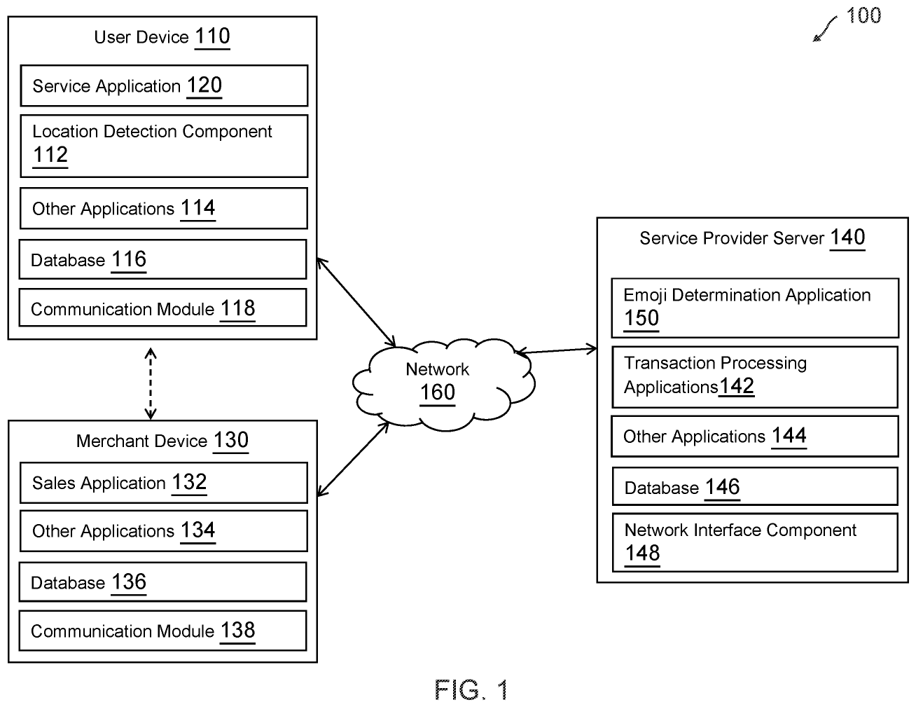

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user device 110, a merchant device 130, and a service provider server 140 in communication over a network 160. A user (not shown) may utilize user device 110 to utilize the various features available for user device 110, which may include processes and/or applications that may perform user authentication through recording visual data of the user while the user mimes emojis or other digital images or icons displayed to the user. In this regard, the user may set past visual data for the user miming emojis with service provider server 140. In order to authenticate the user, the user may later be presented at least one emoji or other image/icon and be asked to mime or imitate the displayed emoji(s). Visual data of the user while miming the displayed emoji(s) may be captured by user device 110, which may then be transmitted to service provider server 140. Service provider server 140 may compare the presently recorded visual data to past recorded visual data of the user in order to authenticate the user.

User device 110, merchant device 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented as a communication device that may utilize appropriate hardware and software configured for wired and/or wireless communication with service provider server 140. For example, in one embodiment, user device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 110 of FIG. 1 contains a service application 120, a location detection component 112, other applications 114, a database 116, and a communication module 118. Service application 120 and other applications 114 may correspond to executable processes, procedures, and/or applications with associated hardware. In other embodiments, user device 110 may include additional or different modules having specialized hardware and/or software as required.

Service application 120 may correspond to one or more processes to execute software modules and associated devices of user device 110 to send, receive, and/or post data between another device, an online platform providing a data feed, and/or with another networked entity, which includes data using location-specific emojis. In this regard, service application 120 may correspond to specialized hardware and/or software utilized by a user of user device 110 to access a communication platform or service and transmit messages. Thus, service application 120 may provide one or more convenient interfaces capable of receiving and displaying entered message content and other input. In some embodiments, service application 120 may be used to directly communicate between users, such as a text messaging, instant messaging, or other messaging service and platform. In some embodiments, service application 120 may permit a user to browse information available over network 160 including accessing webpages, entering information from webpages, and navigating websites through webpages, and providing posts or messages through websites and online platforms. In certain embodiments, service application 120 may be implemented as a web browser configured to view information available over the Internet or access a website of a website provider. For example, service application 120 may be utilized to access websites and engage in online actions with service provider server 140. In other embodiments, service application 120 may be a dedicated application used for message exchange and/or posting.

For example, service application 120 may correspond to a device application, which may be utilized to perform various online and/or virtual actions, including text or instant messaging, electronic transaction processing, merchant shopping and purchasing, social networking, and other types of electronic actions. For example, service application 120 may correspond to messaging applications (e.g., email, SMS/MMS, instant messaging, and/or social networking messaging), Internet browsers (e.g., browser histories and online interactions), Internet search engines, social networking applications, microblogging applications, merchant and shopping applications, mapping applications, or other types of device applications that may be utilize to transmit messages and/or post data on an online portal. Service application 120 may correspond to media viewing/sharing applications, video games, word processors and associated applications, and/or other types of modules, processes, and applications.

In some embodiments, transaction processing may be performed through service application 120, where transaction data and metadata may be tracked and processed for location-specific emoji output. During transaction processing, service application 120 may be utilized to select payment instrument(s) for use in providing payment for a purchase transaction, transfer, or other financial process. As discussed herein, service application 120 may utilize user financial information, such as credit card data, bank account data, or other funding source data, as a payment instrument when providing payment information. Additionally, service application 120 may utilize a digital wallet stored with an account with a payment provider, such as service provider server 140, as the payment instrument, for example, through accessing a digital wallet or account of a user with service provider server 140 through entry of authentication credentials and/or by providing a data token that allows for processing using the account. Service application 120 may be used to enter and/or receive transaction data, including a merchant, merchant device, merchant location, or other identifier, which may be used to determine a location-specific emoji displayed by service application 120 and/or used in another application during messaging. Thus, service application 120 may be used to generate transaction data and metadata.

In some embodiments, service application 120 may be used to determine a location-specific emoji for display on an interface of user device 110 (e.g., output through a graphical user interface (GUI) during messaging creation, entry, and/or transmission). Service application 120 may determine a location of user device 110 using location detection component 112 and/or through other data and metadata available to service application 120. For example, a geo-location of user device 110 may be detected and matched to a merchant location or detected as within a geo-fence. In some embodiments, transactional information for a transaction may include a merchant, device, or location identifier that may be utilized to determine the location of user device 110. The transaction may be associated with metadata, such as a timestamp, location, etc. Additionally, message content, a timestamp for the message, or attached geo-location may be used to determine a location of user device 110. Service application 120 may be utilized to perform short range wireless communications (e.g., NFC or Bluetooth) with merchant device 130 or otherwise detect that user device 110 is in proximity to merchant device 130. Service application 120 may be used to check-in to a location associated with merchant device 130 or post a location of user device 110 at a specific time.

Once the location of user device 110 is determined, as well as other contextual data for selection of a location-specific emoji, service application 120 may determine and/or receive the location-specific emoji and populate the emoji in an interface. Additionally, the location-specific emoji may also be contextual relevant based on the particular generic emoji or text that it is replacing or supplementing and other location, transaction, merchant, and/or device data or metadata known to service application 120. The interface may replace or place next to or nearby a generic emoji and allow for selection of the location-specific emoji for entry into a message. The location-specific emoji may also replace text as the user is typing or on selection of an interface option. The user may revert any changes to generic text and/or emojis through an interface and/or application option within service application 120. The location-specific emoji may be displayed based on a user preference for the emoji and/or a merchant option and may be displayed with a plurality of location-specific emojis based on the location, the available emojis for the location, and/or the contextual data of the user's actions, emotions, or occurrences at the location. In some embodiments, service application 120 may directly determine and populate the location-specific emoji in an interface based on the location determination and a library of location-specific emojis stored on database 116. In other embodiments, the determination may be performed by service provider server 140, as discussed herein. If entered to a message, the location-specific emoji may be tracked by user device 110 and/or service provider server 140 through an identifier associated with the emoji.

Location detection component 112 corresponds to a hardware and/or software feature of user device 110 that assists in detecting a location of user device 110, for example, through a GPS locator and service, triangulation process, mapping application, check-in process/feature, short range wireless communications, or other location detection process. Location detection component 112 may be used to determine a location of user device 110, which may be processed by user device 110 to determine a location-specific emoji and/or shared with service provider server 140 for determination of the emoji. Location detection component 112 may be accessed and utilized by service application 120 when determining and adding metadata to transactional information or may be directly accessed for determination of the data necessary to populate a location-specific emoji in an interface of user device 110.

In various embodiments, user device 110 includes other applications 114 as may be desired in particular embodiments to provide features to user device 110, for example, those applications, processes, and/or features that may not be provided by service application 120. For example, other applications 114 may include security applications for implementing client-side security features, programmatic client applications for interfacing with appropriate application programming interfaces (APIs) over network 160, or other types of applications. Other applications 114 may also include other location detection applications, which may be used to determine a location for the user, such as a mapping, compass, and/or GPS application, which can determine a location of user device 110 and the user through location detection component 112. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of user device 110, such as display devices capable of displaying information to users and other output devices.

User device 110 may further include database 116 stored on a transitory and/or non-transitory memory of user device 110, which may store various applications and data and be utilized during execution of various modules of user device 110. Thus, database 116 may include, for example, identifiers such as operating system registry entries, cookies associated with service application 120 and/or other applications 114, identifiers associated with hardware of user device 110, or other appropriate identifiers, such as identifiers used for payment/user/device authentication or identification, which may be communicated as identifying user device 110 to service provider server 140. Database 116 may include location, transaction, merchant, and/or device identifiers, data, and/or metadata, which may be used to determine a location-specific emoji for a location associated with user device 110 and/or a transaction processed by user device 110. Additionally, a library of location-specific emojis used to populate one or more location-specific emojis based on the location and/or transaction may be stored on database 116.

User device 110 includes at least one communication module 118 adapted to communicate with service provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Merchant device 130 may be implemented using any appropriate hardware and software configured for wired and/or wireless communication with user device 110 and/or service provider server 140 for processing a transaction and generating transaction, location, device, or other data and metadata for determination of a location-specific emoji. Merchant device 130 may correspond to a merchant that provides sales through a physical merchant location. In various embodiments, merchant device 130 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although only one merchant device is shown, a plurality of merchant devices may function similarly.

Merchant device 130 of FIG. 1 contains a sales application 132, other applications 134, a database 136, and a communication module 138. Sales application 132 and other applications 134 may correspond to executable processes, procedures, and/or applications with associated hardware. In other embodiments, merchant device 130 may include additional or different software as required.

Sales application 132 may correspond to one or more processes to execute modules and associated devices of merchant device 130 to provide a convenient interface to permit a merchant for merchant device 130 to enter, view, and/or process items the user wishes to purchase through interactions with user device 110. In this regard, sales application 132 may correspond to specialized hardware and/or software utilized by merchant device 130 that may provide transaction processing and generate transaction data and metadata. Thus, sales application 132 may be implemented as an application having a user interface enabling the merchant to enter and/or view the items a user associated with user device 110 has selected for purchase (e.g., at a merchant location for the merchant, for example, items brought to a checkout register for the merchant and/or requested to be produced by the merchant). Sales application 132 may further enable the merchant to enter coupons and/or discounts for the items, edit the order including adding, removing, and/or modifying items, or other functions with regards the selected items in the purchase order. Once the items have been finalized for purchase by the user, a total may be calculated, and a transaction may be engaged with the user to complete payment for the selected items. Thus, sales application 132 may request payment covering the selected items from the user. Transaction processing to receive a payment may be processed by service provider server 140, which may the user's financial information to provide payment for the transaction to an account of the merchant. Sales application 132 may alert the merchant when payment for the transaction for the item(s) is completed and may provide a transaction history to sales application 132 for generating a receipt to the user associated with user device 110. Additionally, prior to or after completion of the transaction, various location, transaction, merchant, and/or device data and/or metadata may be transmitted to user device 110 and/or service provider server 140 for use in determination of a location-specific emoji.

Merchant device 130 includes other applications 134 as may be desired in particular embodiments to provide features to merchant device 130. For example, other applications 134 may include security applications for implementing client-side security features, programmatic client applications for interfacing with appropriate application programming interfaces (APIs) over network 160, or other types of applications. Other applications 134 may also include email, texting, voice and IM applications that allow a merchant to send and receive emails, calls, texts, and other notifications through network 160. In various embodiments, other applications 134 may include financial applications, such as banking, online payments, money transfer, or other applications associated with a payment provider, such as service provider server 140. Other applications 134 may contain software programs, executable by a processor, including a graphical user interface (GUI) configured to provide an interface to the user.

Merchant device 130 may further include database 136 which may include, for example, identifiers such as operating system registry entries, cookies associated with sales application 132 and/or other applications 134, identifiers associated with hardware of merchant device 130, or other appropriate identifiers, such as identifiers used for payment/user/device authentication or identification. Identifiers in database 136 may be used by a payment/service provider to associate merchant device 130 with a particular account maintained by the payment/service provider. Database 136 may also further store transactional data for a transaction with user device 110. In some embodiments, data and metadata necessary to determine a location-specific emoji when received by user device 110 and/or service provider server 140, such as device identifiers, transaction metadata, and other information, may be stored on database 136.

Merchant device 130 includes at least one communication module 138 adapted to communicate with user device 110 and/or service provider server 140 over network 160. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 14Q may be maintained, for example, by an online service provider, which may provide payment services, as well as use of location-specific emojis, to one or more users. In this regard, service provider server 140 includes one or more processing applications which may be configured to interact with user device 110, merchant device 130, and/or another device/server to facilitate connecting users through messaging. In one example, service provider server 140 may be provided by PayPal®, Inc. of San Jose, Calif., USA. However, in other embodiments, service provider server 140 may be maintained by or include another type of service provider, which may provide the aforementioned services to a plurality of users.

Service provider server 140 of FIG. 1 includes an emoji determination application 150, a transaction processing application 142, other applications 144, a database 146, and a network interface component 148. Emoji determination application 150, transaction processing application 142, and other applications 144 may correspond to executable processes, procedures, and/or applications with associated hardware. In other embodiments, service provider server 140 may include additional or different modules having specialized hardware and/or software as required.

Emoji determination application 150 may correspond to one or more processes to execute software modules and associated specialized hardware of service provider server 140 to provide determination of opportunities to utilize one or more location-specific emojis or other graphical objects within a message sent by user device 110 and process data used to output the location-specific emojis within an interface of user device 110. In this regard, emoji determination application 150 may correspond to specialized hardware and/or software to first receive data necessary to determine a location-specific emoji. In some embodiments, the data may correspond to location, transaction, merchant, device, or other data and/or metadata, such as the data received by user device 110 previously discussed that may be used for the determination of the location specific emoji, which may include a geo-location of user device 110, transactional information for a transaction between user device 110 and merchant device 130, proximity information for a distance or wireless communications between user device 110 and merchant device 130, and/or message content or metadata for a message entered and/or transmitted by user device 110. The information may also include contextual information of a context, action, or occurrence associated with why the user associated with user device 110 is at the location and what the user did or is doing. For example, the contextual information may be based on a user reason for visiting the location, a user action at the location, items purchased, etc.

Service provider server 140 may also interact with merchant device 130 to determine a location of user device 110 and contextual information associated with a visitation to the location by the user associated with user device 110. For example, service provider server 140 may receive transactional information for processing or that was processed by transaction processing application 142, such as a payment to the merchant for a transaction. Emoji determination application 150 may access such information and utilize the transactional information for determination of the location, such as through a merchant device identifier, merchant identifier (e.g., an identifier used to identify the merchant and/or merchant's account when performing transaction processing), and/or location identifier. The information may include metadata associated with the transactional information, such as a timestamp, tagged geo-location, etc.

Emoji determination application 150 may then cause determination of a location-specific emoji based on the accessed and/or received data. In some embodiments, some or all of the processes described herein to determine and display a location-specific emoji on user device 110 may be performed by user device 110 or service provider server 140 alone. For example, user device 110 may utilize a device-side library of location-specific emojis to populate a display on user device 110, such as associated with a text field, based on the aforementioned data, or emoji determination application 150 may perform the determination and push the emoji to user device 110 to display. Thus, the data may be transmitted to user device 110 for determination of the location-specific emoji by emoji determination application 150. Where emoji determination application 150 determines the location-specific emoji, emoji determination application 150 may then push and/or cause the emoji to be displayed within an interface of user device 110, for example, by displaying with a generic emoji, replacing the generic emoji, placing with text, or replacing text.

Emoji determination application 150 may also utilize an identifier or other data of the location-specific emoji to track usage of the location-specific emoji and their corresponding messages and posts. For example, emoji determination application 150 may be used to track visitations to a particular location, messages sent by users and the content of those messages from parsing the words and sentences in the messages, and/or merchant traffic information (e.g., times of visitations). Emoji determination application 150 may be used to provide badges, rewards, and/or advertisements based on use of location-specific emojis, including a number of uses and message content associated with the use. Emoji determination application 150 may communicate usage information to a merchant employee and/or merchant device 130 for use by the merchant employee with communicating back to the user. Additionally, statistics on use of the emoji, such as number of uses, visitations by users, and parsed message content, may be transmitted to the merchant for processing of merchant information, traffic, and comments.

Transaction processing application 142 may correspond to one or more processes to execute software modules and associated specialized hardware of service provider server 140 to provide payment services to users, for example through a payment account and/or payment instruments, which may include generation of transaction data used in determination of a location-specific emoji. In this regard, transaction processing application 142 may correspond to specialized hardware and/or software to provide payment services and payment accounts, including digital wallets storing payment instruments. The payment services may allow for a payment to a user and/or merchant through a payment instrument, including a credit/debit card, banking account, payment account with service provider server 140, and/or other financial instrument. In order to establish a payment account for a user to send and receive payments, transaction processing application 142 may receive information requesting establishment of the payment account. The information may include user personal and/or financial information. Additionally, the information may include authentication information, such as a login, account name, password, PIN, or other account creation information. The user may provide a name, address, social security number, or other personal information necessary to establish the account and/or effectuate payments through the account. Transaction processing application 142 may further allow the user to service and maintain the payment account, for example, by adding and removing payment instruments.

Transaction processing application 142 may be used to determine a current and/or previously processed transaction between user device 110 and merchant device 130. Thus, transaction processing application 142 may further generate transaction data and metadata that is used in determination of a location-specific emoji by emoji determination application 150. Such transactional information may be transmitted to user device 110 and/or processed internally for determination of the emoji. Additionally, transaction processing application 142 may provide additional contextual information for selection of one or more location-specific emojis associated with a context for the transaction or other reason for visiting a location by a user associated with user device 110. In order to perform transaction processing and/or payments, transaction processing application 142 may debit an account of the user and provide the payment to an account of the merchant or other user. Transaction processing application 142 may also be used to provide transaction histories for processed transactions.

In various embodiments, service provider server 140 includes other applications 144 as may be desired in particular embodiments to provide features to service provider server 140. For example, other applications 144 may include security applications for implementing server-side security features, programmatic client applications for interfacing with appropriate application programming interfaces (APIs) over network 160, or other types of applications. Other applications 144 may contain software programs, executable by a processor, including a graphical user interface (GUI), configured to provide an interface to the user when accessing service provider server 140, where the user or other users may interact with the GUI to more easily view and communicate information. In various embodiments, other applications 144 may include connection and/or communication applications, which may be utilized to communicate information to over network 160.

Additionally, service provider server 140 includes database 146. As previously discussed, a user may establish one or more digital wallets and/or payment accounts with service provider server 140. Digital wallets and/or payment accounts in database 146 may include user information, such as name, address, birth date, payment instruments/funding sources, additional user financial information, user preferences, and/or other desired user data. Users may link to their respective digital wallets and/or payment accounts through an account, user, and/or device identifier. Thus, when an identifier is transmitted to service provider server 140, e.g., from user device 110, one or more digital wallets and/or payment accounts belonging to the user may be found. Database 146 may also store a library of location-specific emojis, as well as the necessary data to determine a location-specific emoji for user device 110 (e.g., location and/or contextual information).

In various embodiments, service provider server 140 includes at least one network interface component 148 adapted to communicate user device 110 and/or merchant device 130 over network 160. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

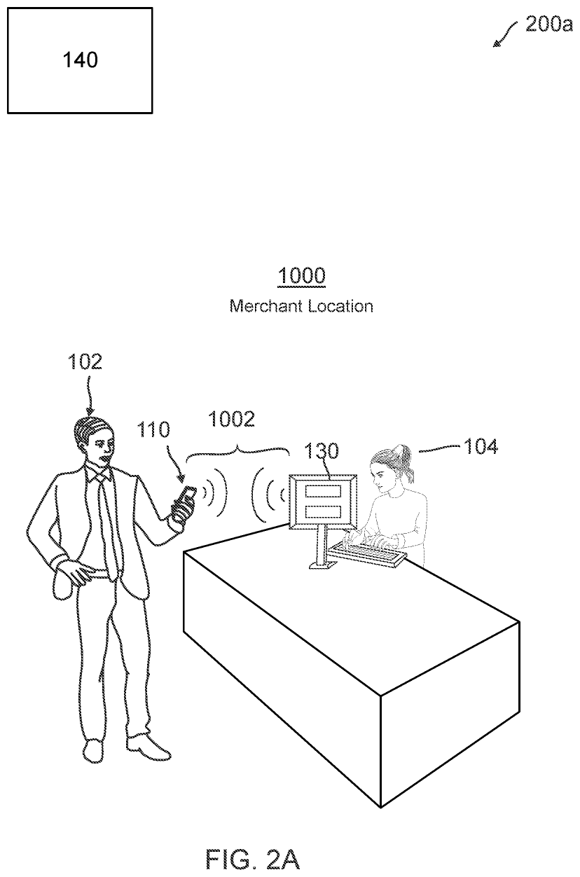

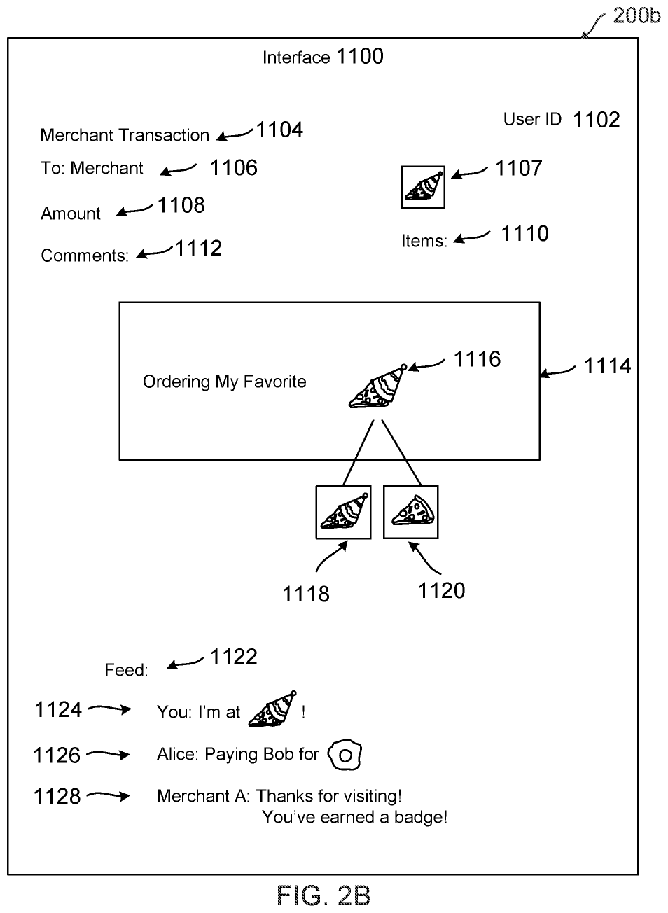

FIG. 2A is an exemplary real-world environment where device and/or transaction metadata may be generated for intelligent display of location-specific emojis, according to an embodiment. Environment 200a of FIG. 2A includes user device 110, merchant device 130, and service provider server 140 in reference to system 100 of FIG. 1. In this regard, user device 110 and/or merchant device 130 may be utilized with service provider server 140 to generate and process data and metadata utilized to determine one or more location-specific emojis, as discussed herein.

For example, a user 102 utilizing user device 110 may visit a merchant location 1000 to interact with a merchant 104 utilizing merchant device 130. When visiting merchant location 1000, user device 110 may generate and/or be associated with location-specific data, such as a geo-location detected using user device 110. For example, user device 110 may generate location-specific data utilizing a GPS detector or other location detection device included within user device 110. In some embodiments, user device 110 may generate the location-specific with merchant device 130, for example, over communications 1002. Communications 1002 may correspond to short range wireless communications, such as NFC or Bluetooth, used to detect nearby devices and exchange identifiers. Thus, user device 110 may receive an identifier used during communications 1002 with merchant device 130, or merchant device 130 may receive an identifier for user device 110 over communications 1002. These device identifiers and a known location for merchant device 130 at merchant location 1000 may be used to determine that user device 110 is located at and identify merchant location 1000. Moreover, communication 1002 and/or network communications may be utilized to perform a check-in of user device 110 at merchant location 1000 in order to establish that user device 110 is located at merchant location 1000 for use in determining a location-specific emoji.

Communications 1002 may also generate transaction data and metadata based on exchanged data during checkout and transaction processing. For example, communications 1002 may be used to exchange identifiers, tokens, and/or payment information during checkout for a transaction in order to process the transaction and provide a payment to the merchant associated with merchant device 130. Transaction data and metadata may include a merchant location identifier for merchant location 1000, a device identifier for merchant device 130, a geo-location tagged by user device 110, a timestamp of the transaction used to determine that user device 110 is located at merchant location 1000. Once generated, service provider server 140 may process the transaction data. Additionally, user device 110 and/or service provider server 140 may determine the location-specific emoji using the aforementioned data, as discussed herein.

In some embodiments, user device 110 and/or service provider server 140 may also determine the data necessary for selection of a location-specific emoji using other data and/or metadata. For example, a feed of user posts, including transaction related posts, may include geo-location tags and/or merchant device identifiers used to determine a location of user device 110. Additionally, service provider server 140 may also access the feed from another online resource, such as a social networking platform or other posting service that allow user device 110 to post data. User device 110 and/or service provider server 140 may also determine the data and/or metadata for selection of the location-specific emoji using contextual data entered to user device 110, such as a content of messages and/or transactional information, user information or a user history (e.g., a reason for visitation to merchant location 1000), and the like.

FIG. 2B is an exemplary graphical user interface of an application displaying location-specific emojis selected for output based on detected device and/or transaction metadata, according to an embodiment. Environment 200b includes user device 110 displaying an interface 1100, where user device 110 is described in reference to system 100 of FIG. 1. In this regard, a user viewing interface 1100 on user device 110 may view processes and features of user device 110 to display a location-specific emoji to a user.

Interface 1100 in environment 200b displays an interface of user device 110 when interface 1100 displays a location-specific emoji based on accessible data and metadata used to determine a location of user device 110. For example, interface 1100 displays a feed for a user associated with user ID 1102 when the user is logged in to the application displaying interface 1100. Interface 1100 displays a merchant transaction 1104 having a merchant A identifier 1106 for the merchant and a logo 1107. Logo 1107 may be a specific graphical object associated with merchant A identifier 1106 and may be used to determine a location-specific emoji (e.g., where logo 1107 is used to generate a location-specific emoji so that the emoji identifies a message or post as being associated with the merchant). Transaction data, such as an amount 1108 and items 1110 may also be displayed with merchant transaction 1104 and may correspond to additional data and metadata used to determine a location-specific emoji.

Interface 1100 may also be used to enter comments 1112 using a message field 1114. During typing or entry (such as through voice) of message content into message field 1114, a location-specific emoji 1116 may be entered to message field 1114 after determination of location-specific emoji 1116 using at least a location of user device 110. Location-specific emoji 1116 is shown as similar to logo 1107 so that location-specific emoji in comments 1112 may be specific to the location and identify the comments as being generated at or associated with the location of user device 110. This allows more specific communication of information and customized graphical objects based on a location of user device 110. Location-specific emoji 1116 may be selected from a menu showing location-specific emoji selection option 1118 and generic emoji selection option 1120. Options 1118 and 1120 may allow a user to choose entry of location-specific emoji 1116 into comments 1112 or a more generic emoji. Additionally, options 1118 and 1120 may also include additional location-specific emojis based on a location of user device 110 and/or contextual data associated with merchant transaction 1104 and/or a reason for visiting the location used to determine location-specific emoji 1116.

Interface 1100 may also display a feed 1122 that include certain location-specific emojis so that users can view use of the emojis and better convey information associated with a specific location. Feed 1122 include a user comment 1124 by user ID 1102 (e.g., a post by user ID 1102). As shown in interface 1100, user comment 1124 using location-specific emoji 1116 in the comment enables user comment 1124 to be specific to a location of user device 110. Additionally, feed 1122 includes a friend post 1126 that also includes an emoji during the comment. A user may view feed 1122 to determine a location of friend post 1126 based on the emoji used during friend post 1126. Feed 1122 also includes a reply 1128 by a merchant that may be posted in response to detection of use of location-specific emoji 1116 in user comment 1124. Reply 1128 also includes an earned badge based on use of location-specific emoji 1116.

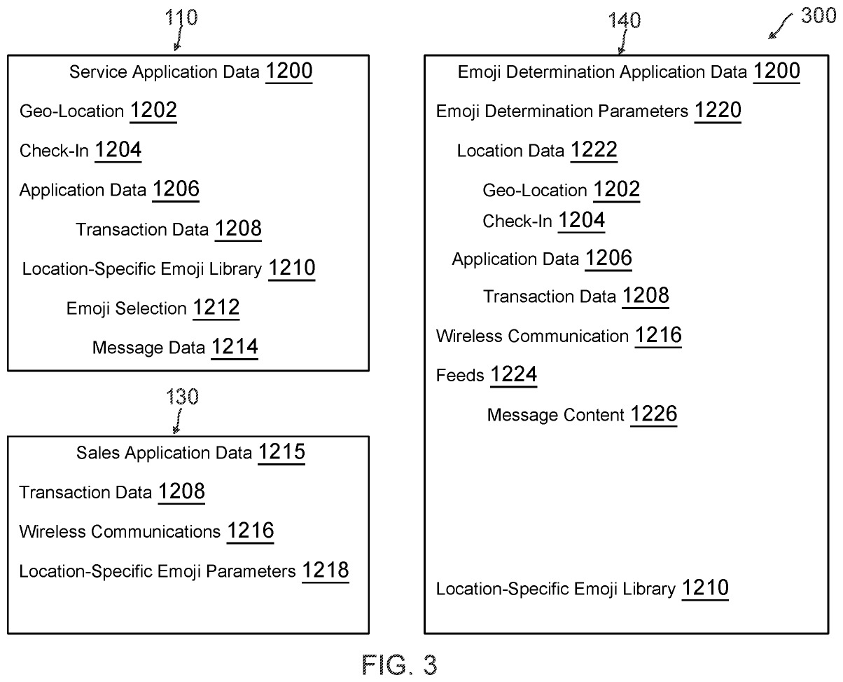

FIG. 3 is an exemplary system environment showing a communication device interacting with a service provider for authenticating a user through visual data of a user miming displayed images, according to an embodiment. FIG. 3 includes user device 110, merchant device 130, and service provider server 140 both discussed in reference to system 100 of FIG. 1.

User device 110 includes service application data 1200 that may be determined and processed by service application 120 in system 100. In this regard, service application data 1200 includes data and metadata used to determine a location-specific emoji. For example, service application data 1200 includes a geo-location 1202 detected by user device 110, for example, through a GPS or similar component. In some embodiments, check-in 1204 may be used to identify a location of user device 110 by establishing that user device 110 is located at a location through a check-in service (including short range wireless communications). Service application data 1200 may also include application data 1206 that may be used to determine a location of user device 110. For example, transaction data 1208 may include data and metadata of a transaction that may be used to identify user device 110. This may include merchant device identifiers, merchant locations, a timestamp, and/or other data used to determine where user device 110 is located at a time. In some embodiments, service application data 1200 may also include a location-specific emoji library 1210 that may be used for an emoji selection 1212 using in message data 1214. However, in other embodiments, service provider server 140 may store location-specific emoji library 1210 so that determination of emoji selection 1212 may be performed by service provider server 140 and pushed to user device 110.

In some embodiments, merchant device 130 may be further used to generate location-specific data for determination of an emoji at a location of user device 110. Merchant device 130 includes sales application data 1215 that may be determined and processed by sales application 132 in system 100. In this regard, sales application data 1215 includes transaction data 1208 generated with user device 110 and may include a device identifier for user device 110 to identify that user device 110 generated the transaction with merchant device 130 at the location. Sales application data 1215 may also include wireless communications 1216 that may occur between user device 110 and merchant device 130 while user device 110 is at a location associated with merchant device 130. Sales application data 1215 may also be used to specify location-specific emoji parameter 1218, which may designate which of multiple location-specific emojis may be selected based on certain user interactions and/or metadata associated with the user's visit to a location (e.g., time of day, season, etc.).

Service provider server 140 includes emoji determination application data 1219 that may be determined and processed by emoji determination application 150 in system 100. In this regard, emoji determination application data 1219 includes data received from user device 110 and merchant device 130. For example, emoji determination parameters 1220 include location data 1222, such as geo-location 1202 detected by user device 110 and/or check-in 1204 processed by user device 110. Emoji determination parameters may also include application data 1206 received from data processed by one or more applications on user device 110, and may include specific application data and metadata used to determine a location of user device 110 (e.g., transaction data 1208). Emoji determination parameters 1220 may also include wireless communications 1216 that identify data exchanged between user device 110 and merchant device 130. In some embodiments, service provider server 140 may also process feeds 1224 having message content 1226, which may include location designations and may be processed to determine location and/or contextual data used for emoji selection 1212.

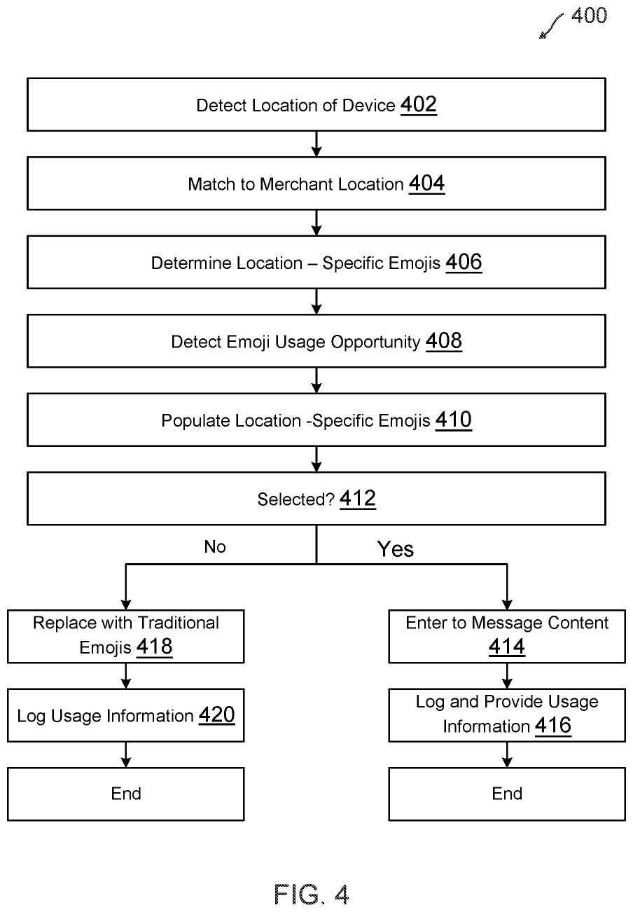

FIG. 4 is a flowchart of an exemplary process for visual data processing of mimed images for authentication, according to an embodiment. Note that one or more steps, processes, and methods described herein of flowchart 400 may be omitted, performed in a different sequence, or combined as desired or appropriate.

At step 402 of flowchart 400, a location of a device is detected, for example, through determination of a device geo-location, processing of transaction data and/or metadata, or other information available to the device or a service provider server. The location of the device may also be detected through information from another device, such as a merchant device at the location. Once the location is determined, the location is matched to a merchant location, at step 404. For example, the location may be detected as within a geo-fence or may be matched to known locations for a merchant. Once the specific merchant location is associated with the device, at step 406, location-specific emojis are determined. This may be through lookup of the emojis using a library stored on the device and/or by a service provider server. The library may include one or more emojis for the location which may be used to specify a particular emoji with a location so that the emoji more particularly conveys location specific information. Where multiple emojis are associated with a location, each of the emojis may be selected from the library for presentation on the device. However, particular emojis may also be presented instead of all of the location-specific emojis. In such embodiments, the particular emojis may be selected based on the emoji that they are replacing and/or contextual information for the device. The contextual information may include information associated with a user's message and/or reason for visiting a location, which may make selection of the emoji(s) more particular.

At step 408, an emoji usage opportunity is detected. The emoji usage opportunity may correspond to an action that a user takes on the device, such as opening an application that utilized the emojis, entering text into a message or content, and/or processing a transaction that may be posted to a feed. The emoji usage opportunity may also correspond to a request to utilize the emoji within an application, such as by opening an emoji usage window. The location-specific emojis are populated to an interface of the device, at step 410. The emojis may be presented with generic emojis and/or replace generic emojis and may include an option to hide one or more emojis or revert the emojis to their generic form. In some embodiments, the emoji may also replace or be populated next to text that the emoji is meant to replace and/or represent. The emojis may also be added to text that is already entered to a message and/or change the outlook of a generic emoji that has already been added to the message. The population of the emojis within the interface may be performed by the device when the device determines the location-specific emojis or may be pushed to the device from a service provider server.

At step 412, it is determined whether the emoji is selected for utilization in a message. For example, the user may utilize input to select the emoji, hide the emoji, or otherwise interact with the emoji. If the emoji is selected, the emoji is entered to message content, at step 414. The device and/or a service provider also log the usage and provide usage information, at step 416. The usage information may be used to interact back with the device, such as through an advertisement or reply post on a social networking platform. The usage information may also be used to track user comments about a merchant location, determine user traffic flow based on the emoji usage and additional metadata of the usage, and/or provide other information back to the user. However, if an emoji is not selected, the emojis may be replaced with traditional emojis, at step 418. The traditional emojis may be generic emojis not specifically associated with the location and may be generically used. Additionally, at step 420, the lack of usage and/or information on other emoji usage is tracked and provided to the service provider and/or merchant for data processing. This may assist the service provider and/or merchant in refining their location-specific emoji suggestion processes.

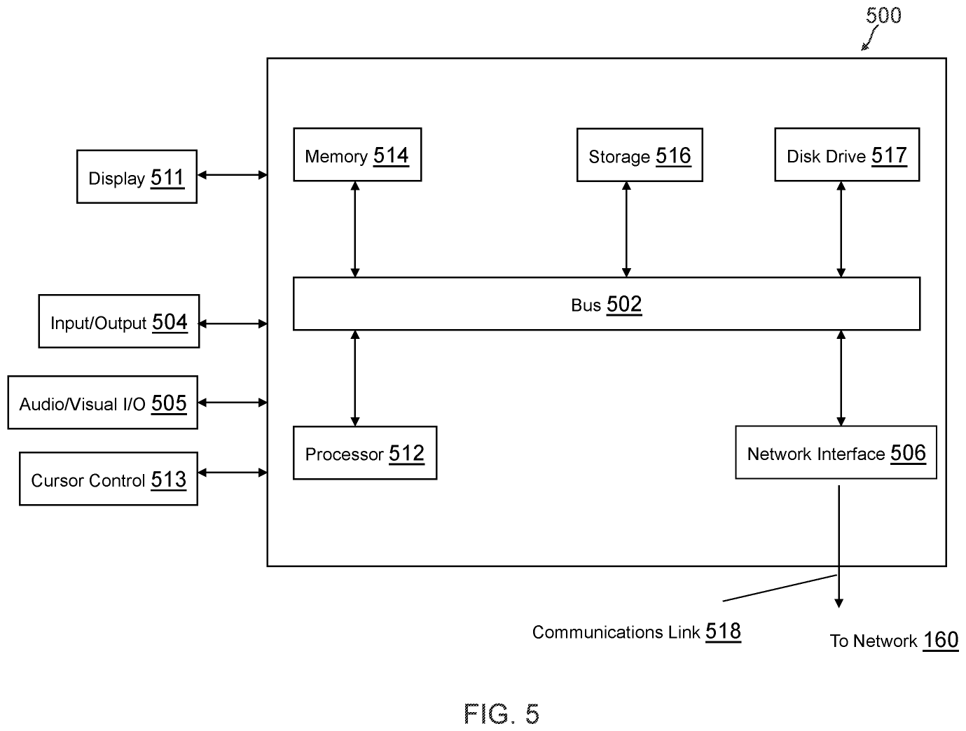

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A device comprising:
a non-transitory memory storing instructions; and
one or more hardware processors coupled to the non-transitory memory and configured to read the instructions from the non-transitory memory to cause the device to perform operations comprising:
determining a geo-location of a user device;
determining that the geo-location is within a geo-fenced area associated with a location-specific emoji for an entity within the geo-fenced area, the location-specific emoji usable with message content transmitted by an application running on the user device;
accessing the location-specific emoji associated with the geo-fenced area;
receiving, through the application, user input associated with the message content; and
in response to the receiving, populating the location-specific emoji in the message content within an interface of the application.

2. The device of claim 1, wherein prior to populating the location-specific emoji, the operations further comprise;
determining that the user input corresponds to an emoji;
determining that the location-specific emoji is a substitute for the emoji; and
receiving a selection of the location-specific emoji.

3. The device of claim 2, wherein the determining that the user input corresponds to the emoji comprises:
parsing text of the user input; and
determining that a word or a phrase is replaceable by or corresponds to the emoji,
wherein the location-specific emoji replaces or follows the word or the phrase.

4. The device of claim 1, wherein the operations further comprise:
accessing transaction data for a transaction within the geo-fenced area, wherein the transaction is processed by the application on the user device, wherein the transaction data comprises a merchant identifier, and wherein the message content is associated with the transaction; and
displaying the transaction with the message content in the interface of the application.

5. The device of claim 4, wherein the determining the geo-location is based on the merchant identifier and merchant location data from a service provider that processes the transaction.

6. The device of claim 4, wherein the transaction data comprises metadata of the transaction, wherein the location-specific emoji comprises one of a plurality of location-specific emojis, and wherein the operations further comprise:
selecting the location-specific emoji from the plurality of location-specific emojis based on the metadata of the transaction.

7. The device of claim 1, where the determining the geo-location is through a location detection component configured to determine the geo-location of the user device, and wherein the determining that the geo-location is within the geo-fenced area is through a service provider associated with the geo-fenced area.

8. The device of claim 1, wherein the location-specific emoji is accessed from a service provider server associated with the geo-fenced area, and wherein the location-specific emoji is populated in the application through an application add-on, an extension, or another application provided by the service provider server.

9. The device of claim 1, wherein the location-specific emoji comprises one of a plurality of location-specific emojis, wherein each of the plurality of location-specific emojis are associated with user designation information comprising at least one of a user characteristic, a user rank with a social networking service, or an employment status with a merchant associated with the geo-fenced area, and wherein the operations further comprise:
accessing user information for the user;
comparing the user information to the user designation information; and
selecting the location-specific emoji from the plurality of location-specific emojis based on the comparing.

10. The device of claim 1, wherein the device comprises one of the user device or a service provider server associated with the location-specific emoji.

11. The device of claim 1, wherein the populating the location-specific emoji comprises replacing text in the message content with the location-specific emoji.

12. A system comprising:
a non-transitory memory storing instructions; and
one or more hardware processors coupled to the non-transitory memory and configured to read the instructions from the non-transitory memory to cause the system to perform operations comprising:
detecting metadata for a transaction between a mobile device and a merchant device;
detecting that the mobile device initiates a message associated with the transaction;
determining that the message is associated with a generic emoji;
determining, based on metadata associated with the transaction, a location-specific emoji as a substitute for the generic emoji in the message associated with the transaction; and
causing to be displayed, through an application on the mobile device, the location-specific emoji with the message.

13. The system of claim 12, wherein the detecting the metadata comprises one of:
receiving the metadata from the mobile device in response to initiation of the transaction using an application on the mobile device;
receiving the metadata from the merchant device in response to the merchant device processing the transaction;
detecting the mobile device within a proximity to the merchant device, wherein the metadata comprises the proximity between the mobile device and the merchant device; or
detecting a pairing of the mobile device and the merchant device using short range wireless communications, wherein the metadata comprises the pairing.

14. The system of claim 12, wherein the metadata comprises a merchant device identifier for the merchant device, and wherein the location-specific emoji is determined by:
determining a merchant location for the mobile device based on the merchant device identifier; and
determining that the merchant location provides the location-specific emoji in place of the generic emoji,
wherein the causing the location-specific emoji to be displayed comprises replacing the generic emoji with the location-specific emoji when the generic emoji is selected for the message.

15. The system of claim 12, wherein the operations further comprise:
detecting a geo-location of the mobile device through a location detection component of the mobile device, wherein the location-specific emoji is further based on the geo-location matching a merchant location for the transaction.

16. The system of claim 12, wherein the operations further comprise:
detecting that the location-specific emoji is used with the message;
determining a plurality of uses of the location-specific emoji for a merchant associated with the merchant device; and
providing usage information of the location-specific emoji to the merchant, wherein the usage information is associated with the location-specific emoji used with the message and the plurality of uses.

17. The system of claim 16, wherein the operations further comprise:
determining a merchant employee associated with a merchant location for the merchant device; and
transmitting a notification to the merchant employee that the location-specific emoji was used with the message, wherein the notification comprises an identifier associated with the mobile device.

18. The system of claim 17, wherein the notification comprises a merchant interaction process for the merchant employee with a user associated with the mobile device through the identifier, and wherein the merchant interaction process comprises one of posting a response to the message, providing feedback to the message, providing a benefit to the user based on the message, providing a graphical badge for an application on the mobile device, or increasing a social networking rank associated with the user.

19. The system of claim 12, wherein the operations further comprise:
detecting that the location-specific emoji is used with the message; and
providing an advertisement specific to the location-specific emoji to the mobile device.

20. A non-transitory machine-readable medium having stored thereon machine-readable instructions executable to cause a machine to perform operations comprising:
detecting message input to a message transmitted by an application on a user device;
determining that the message input comprises a request to enter a generic messaging icon within the message;
determining a location of the user device;
determining that the location corresponds to a location-specific messaging icon as an additional icon for the generic messaging icon in the message; and
outputting the location-specific messaging icon based on the message input.
